(19) United States
(12) Patent Application Publication
(10) Pub. No.: US 2013/0097007 A1
(43) Pub. Date: Apr. 18, 2013

(54) MEDIA POSTING SYSTEM AND METHOD

(71) Applicant: Joseph Brewer, New York, NY (US)

(72) Inventor: Joseph Brewer, New York, NY (US)

(21) Appl. No.: 13/271,278

(22) Filed: Oct. 12, 2011

(51) Int. Cl. G06Q 30/02

(52) U.S. Cl. 705/14.41

(57) ABSTRACT

A media posting system and method for managing a media advertising order with respect to a media outlet are disclosed. The media advertising order can be ordered via a media ordering application. Exact time data with respect to the media outlet can be extracted from a traffic sub-system. Exact time data can be stored in a database and linked with the ordered spot. Audience delivery data obtained from a rating unit can be merged into the database and linked with the ordered spot and the exact time data. A report with respect to the ordered spot can be generated and displayed on a user interface by comparing the estimated audience delivery data associated with the media advertising order to an actual audience delivery data. At least one of the reports may be based on at least one of: a market criterion; a media station criterion; and a national buy criterion.

### TECHNICAL HELD

Embodiments are generally related to media communication and broadcasting systems and methods. Embodiments are also related to media posting techniques. Embodiments are additionally related to methods and systems for managing an advertising spot with respect to a media outlet.

### BACKGROUND OF THE INVENTION

Advertising forms an important part of broadcast programming including radio, broadcast video (e.g., television), and printed media. Media buyers such as, for example, an advertising agency are being presented with an ever-increasing number of options in client representation. For example, advertising media such as television and radio broadcasting have experienced a growth in the number of broadcasters, and thus, the number of advertising opportunities that they are capable of offering. Conventional techniques for purchasing an advertising spot to develop an advertising campaign is frequently a time-consuming, taxing process with considerable resources spent in sorting through, identifying, and purchasing the optimum available advertising spot for a given campaign. Additionally, high-definition spots add another layer of intricacy and increased manual processes.

The majority of prior art approaches employ some sort of automated system for providing a report with respect to the advertising campaign and to the advertiser. Such approaches are unable to effectively calculate a real-time audience delivery report with respect to the advertisement. Hence, the advertisers are unable to receive the verification of delivery and broadcast of the advertising campaigns for up to weeks after the scheduled run of the advertisement. Additionally, such approaches do not provide an accurate and timely mechanism for monitoring and tracking the delivery and broadcast of the advertisement with respect to all media outlets in a national buy.

Based on the foregoing, it is believed that a need exist for an improved media posting system and method. A need also exists for an improved method for managing and monitoring an advertising spot with respect to a media outlet, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiment to provide for an improved media posting system and method.

It is another aspect of the disclosed embodiment to provide for an improved advertising spot management and monitoring system and method.

It is a further aspect of the disclosed embodiment to provide for an improved system and method for managing and monitoring the advertising spot with respect to a media outlet.

The aforementioned aspects and other objectives and advantages can now be achieved as described herein. A media posting system and method for managing an advertising campaign with respect to a media outlet is disclosed herein. The media advertising spot can be ordered via a media ordering application and an exact time data with respect to the media outlet for posting can be extracted from a traffic sub-system. The exact time data can be stored in a database (e.g., a SQL database) and linked with the ordered spot. An audience delivery data obtained from a rating unit can be merged into the database and linked with the ordered spot and the exact time data. One or more reports with respect to the ordered spot can be displayed via a user interface (e.g., web-based, or an application operating independently of a web browser) by comparing the estimated audience delivery data associated with the ordered spot to an actual audience delivery data with respect to an executed spot. Such an optimized mechanism can interactively manage the advertising spot with respect to the media outlet in a simple and efficient manner.

The user interface generates the report based on varying criteria (e.g., market, station or national buy criteria) and includes exact time run information with respect to the ordered spot. The system may optionally provide a promised audience delivery report, an actual audience delivery report, and/or a percentage of promised audience delivery report with respect to the advertising spot. The audience delivery data can include one or more survey books such as, for example, an ordered book representing the delivery information with respect to the advertising spot in the media station. The audience delivery data with respect to the media order can be calculated based on the information provided in the survey book, which facilitates a user (e.g., an advertiser) to make a media advertising purchase decision with respect to the selected advertising spot.

### BRIEF DESCRIPTION OF THE DRAWINGS

The accompanying figures, in which like reference numerals refer to identical or functionally-similar elements throughout the separate views and which are incorporated in and form a part of the specification, further illustrate possible embodiments and, together with the detailed description, serve to explain the principles of the embodiments described herein.

FIG. 1 illustrates a schematic view of a data-processing system in which an embodiment may be implemented;

FIG. 2 illustrates a schematic view of a software system including an operating system, application software, and a user interface for carrying out an embodiment;

FIG. 3 illustrates a block diagram of a media posting system for managing an advertising spot with respect to a media outlet, in accordance with the disclosed embodiments;

FIG. 4 illustrates a detailed block diagram of the media posting system, in accordance with the disclosed embodiments;

FIG. 5 illustrates a high level flow chart of operation illustrating logical operational steps of a method for managing the advertising spot with respect to the media outlet, in accordance with the disclosed embodiments;

FIG. 6 illustrates a graphical user interface that displays a media post selection criteria for an entire campaign, in accordance with the disclosed embodiments;

FIG. 7 illustrates a graphical user interface of a header screen associated with a media posting application, in accordance with the disclosed embodiments;

FIG. 8 illustrates a graphical user interface of a selection screen associated with the media posting application, in accordance with the disclosed embodiments;

FIG. 9 illustrates a graphical user interface that displays a report viewer, in accordance with the disclosed embodiments; and

FIG. 10 illustrates a graphical user interface that displays data contained within a report viewer, in accordance with disclosed embodiments.

### DETAILED DESCRIPTION

The particular values and configurations discussed in these non-limiting examples can be varied and are cited merely to illustrate at least one embodiment and are not intended to limit the scope thereof.

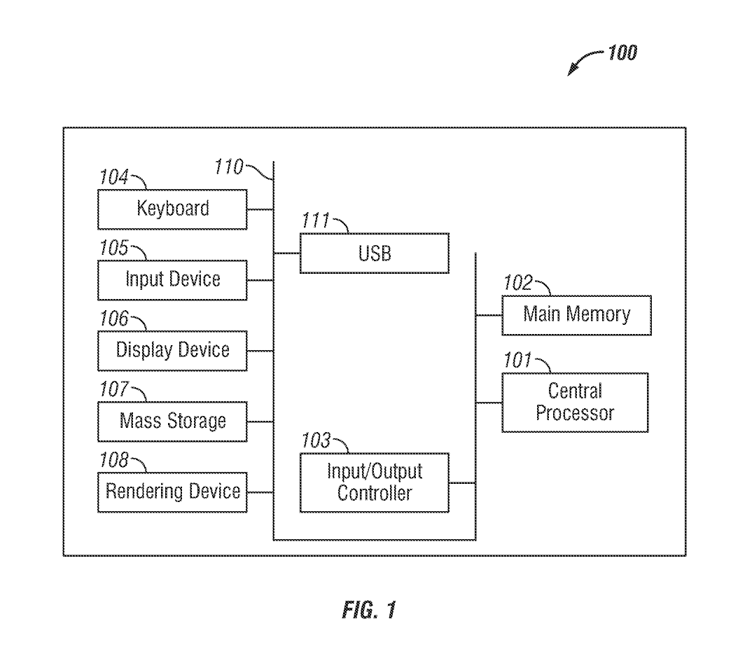

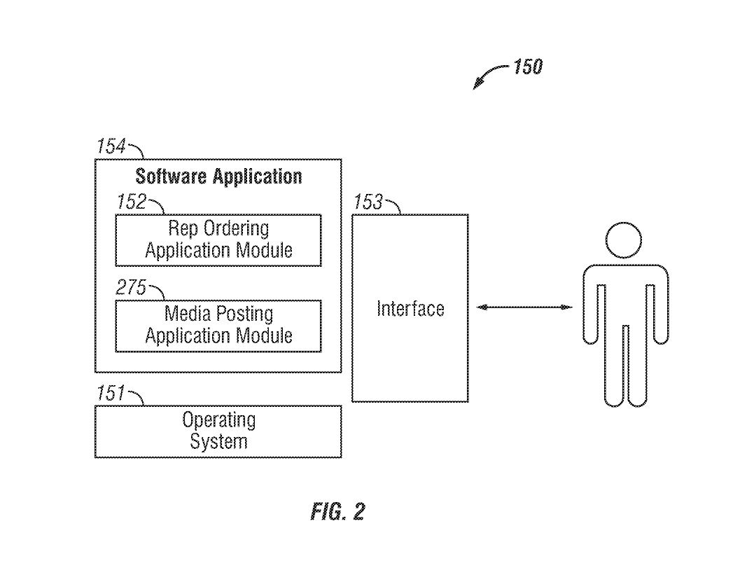

FIGS. 1-2 are provided as exemplary diagrams of data-processing environments in which one or more embodiments may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, pen device, etc.), a display device 106, a mass storage 107 (e.g., a hard disk, removable storage), and a USB (Universal Serial Bus) peripheral connection 111. Additional input/output devices, such as a rendering device 108 (e.g., printer, scanner, fax machine, etc.), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, may generally include a kernel or operating system 151 and a shell or interface 153. One or more application programs, such as software application 154, may be “loaded” (i.e., transferred from mass storage 107 into the main memory 102) for execution by the data-processing system 100. The data-processing system 100 may receive user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In some instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

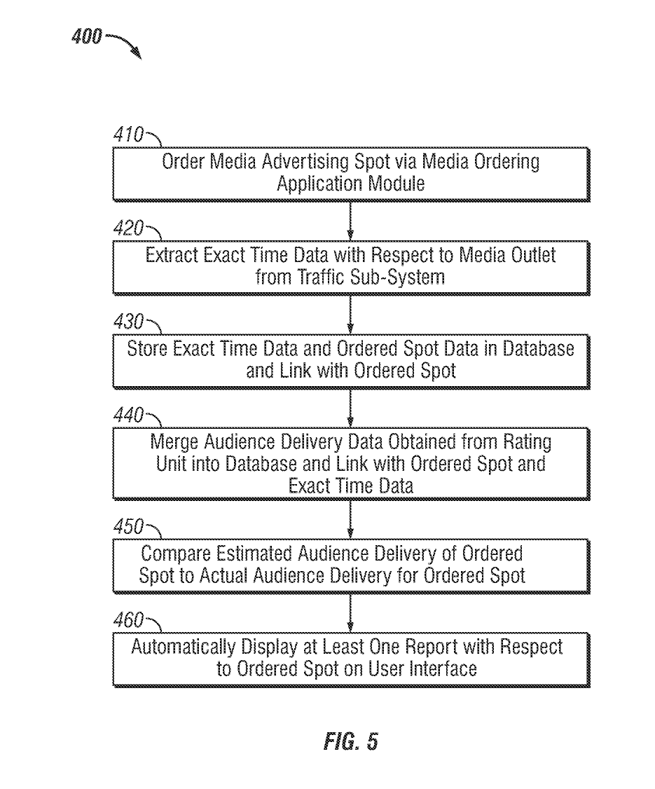

The interface 153, which may be a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include, for example, a representative, or “rep” ordering application module 152 for managing an advertising spot with respect to a media outlet. The rep ordering application module 152 can include instructions such as those of method 400 discussed herein with respect to FIG. 5.

FIGS. 1-2 are thus intended as an example and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, some embodiments may include a variety of different computing platforms including Macintosh, UNIX, LINUX, and the like.

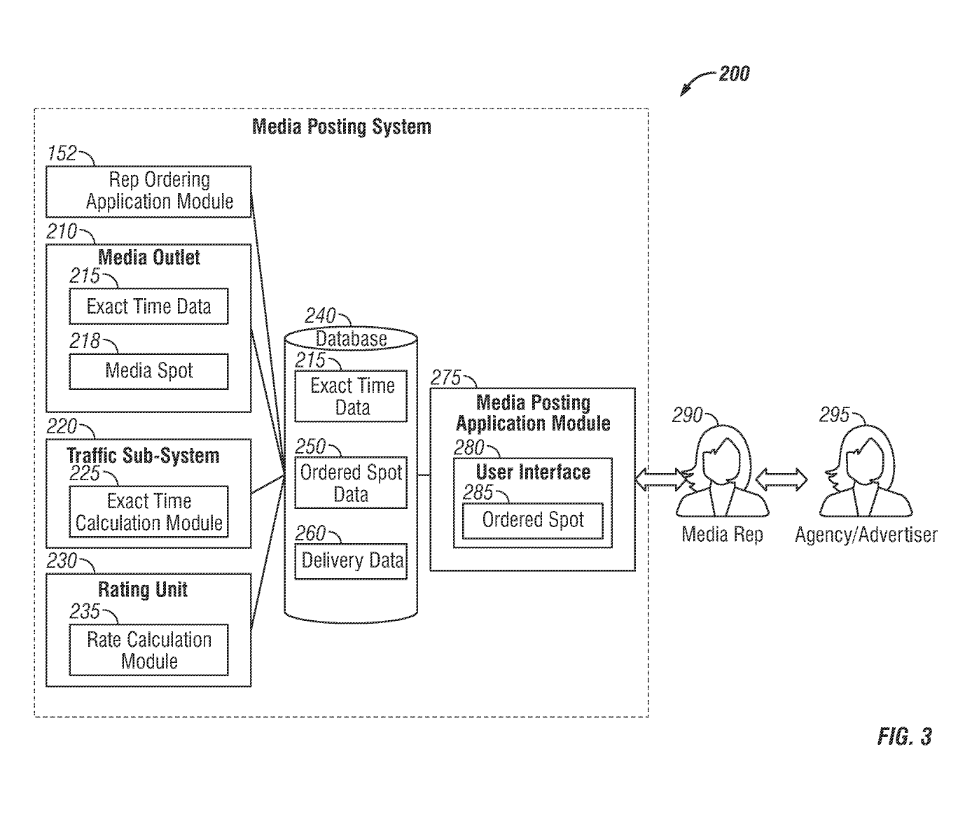

FIG. 3 illustrates a block diagram of a media posting system 200 for managing an ordered spot (media advertising order) 285 with respect to a media outlet 210, in accordance with the disclosed embodiments. In some embodiments, media advertising order 285 may include one advertising spot. In some embodiments, however, media advertising order 285 may include more than one advertising spot. For example, in some embodiments, media advertising order 285 may include a plurality of advertising spots forming an advertising campaign. Note that in FIGS. 1-9, identical parts or elements are generally indicated by identical reference numerals.

The media posting system 200 may generally include the ordering application module 152 and media outlet 210 that are configured in association with a traffic sub-system 220 and a rating unit 230. Note that the system can be adapted for selection and purchase of advertising from different types of advertising media such as, for example, radio, television, or digital. The media outlet 210, as used herein, can encompass local media outlets (e.g., local radio and television stations) that may be distributed in multiple markets, an entire market of local media outlets (e.g., all of the radio or television stations in a particular city), regional media outlets (e.g., regional radio and television stations), national media outlets, and media outlets that broadcast via the Internet or satellite, and combinations thereof.

In some embodiments, one or more advertisements may be associated with exact time data. In some embodiments, the exact time data may indicate the time that the advertisement was actually aired as opposed to the time that the advertisement was scheduled to air. In some embodiments, exact time data may include data that identifies the actual minute that an advertisement aired. In some embodiments, exact time data may include data that identifies the actual second that an advertisement aired. In some embodiments, exact time data may include data that identifies the actual time the advertisement began to air and the actual time the advertisement finished airing.

A media advertising order 285 can be ordered via the rep ordering application module 152. The rep ordering application module 152 may process a media advertising order 285 and create a media-advertising schedule with respect to an advertiser 295. The media outlet 210 from which the spot can be purchased can provide exact time data 215. The media advertising order 285 associated with the media posting application module 275 may list spots that are scheduled to be presented by the media outlet 210 and purchased via an optional media rep 290 by an advertiser 295. The media advertising order 285 may also include media campaign parameters with respect to a spot. Note that the media advertising order 285 may be represented in different ways other than lists, such as being referenced indirectly by pointers, and may be stored in a number of different locations. In this example, the ordered spot data 250 can be stored in a database 240.

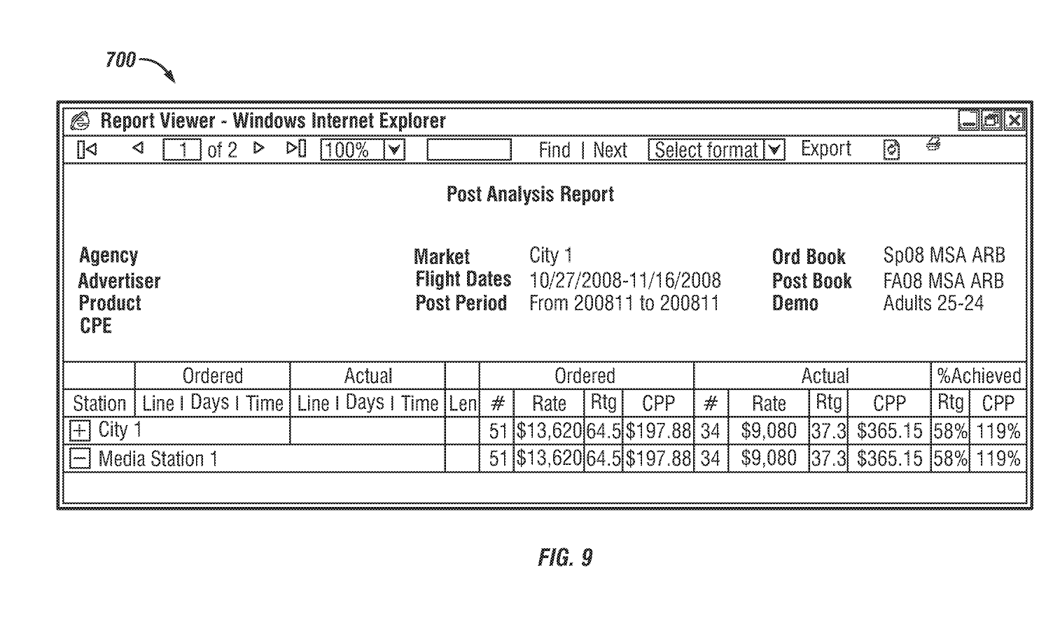

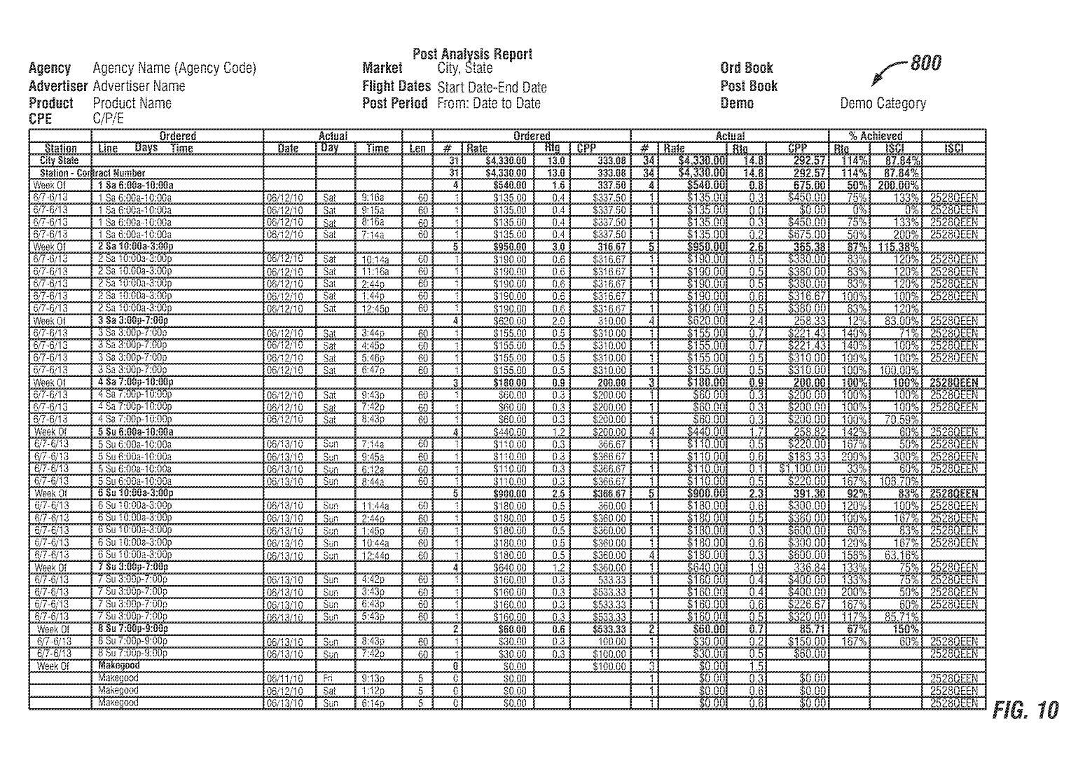

Upon retrieving the exact time data 215 and media advertising order 285, the media posting application 275 may match the exact time data 215 to the media advertising order 285. In some embodiments, the media rep 290 typically accesses the media posting application 275 associated with the media outlet 210 on behalf of the advertiser 295 in order to post the media advertising order 285 and provide a report. In some embodiments, a report may include some or all of the information and features discussed in more detail in in FIGS. 9 and 10.

The traffic sub-system 220 may also include an exact time data calculation module 225 which can be employed to extract an exact time data 215 with respect to the media outlet 210. The exact time data 215 can be stored in a database 240 and linked with the media advertising order 285. Note that the database can be a SQL (Set Query Language) database. The exact time data 215 can identify the actual minute that the media advertising order 285 ran in the media outlet 210. The rating unit 230 may further include a rate calculation module 235 which can be employed to obtain an audience delivery data 260. The audience delivery data 260 can be merged into the database 240 and linked with the media advertising order 285 and the exact time data 215. Merging the audience delivery data 260 with data relating to the media advertising order 285 and exact time data 215 allows for more efficient reviewing and reporting on each advertisement by consolidating the data. This may reduce the amount of time necessary for gathering the data and may allow for more efficient reviewing of each advertisement.

The rating unit 230 may employ statistics from third party data providers to generate data analysis for scheduling and assisting the advertisers 295 for spot purchase decisions. The rating unit 230 may also calculate the efficiency of any particular spot program generated. The rating unit 230 may further permit users to make independent, accurate, and informed decisions regarding their media. Note that third party companies such as, for example, Nielsen® and Arbitron® can provide the ratings. The audience delivery data 260 may be provided in different computer formats including a comma-delimited format. One or more reports with respect to the media advertising order 285 can be simultaneously displayed on a user interface 280 by comparing the estimated audience delivery of the media advertising order 285 to an actual audience delivery for the ordered spot that can subsequently be invoiced. In some embodiments, the user interface 280 can be web-based. In some embodiments, however, the user interface 280 can be an application that operates independently of a web browser.

The audience delivery data 260 can include one or more survey books such as an ordered book representing the delivery information with respect to the media advertising order 285 in the media outlet 210. In some embodiments, survey books, ordered books, or ordered survey books may be in electronic format. For example, in some embodiments, ordered survey books may be stored on a hard drive, disk, or flash memory in connection with a processor. In some embodiments, ordered survey books may be included in software in the form of computer-readable memory stored in the memory of a processor, or other storage medium. In some embodiments, the ordered survey books may include data stored on paper or other format that may be manually referenced.

The system 200 may calculate the audience delivery data 260 for the media advertising order 285 based on the information provided in the survey books. The advertiser 295 may also employ such information in order to make subsequent media advertising purchase decision with respect to the selected media advertising order 285. The user interface 280 may generate the reports based on varying criteria such as, for example, advertisements relating to a particular market, advertisements relating to a particular media station, and/or advertisements relating to a particular national buy with respect to the media advertising order 285. Such reports may include ETR information with respect to the media advertising order 285. The rep ordering application 152 may process the media advertising order 285 utilizing such reports and may create a media-advertising schedule with respect to the advertiser 295. The system 200 may optionally provide a promised audience delivery report, an actual audience delivery report, and/or a percentage of promised audience delivery achieved in the media advertising order 285.

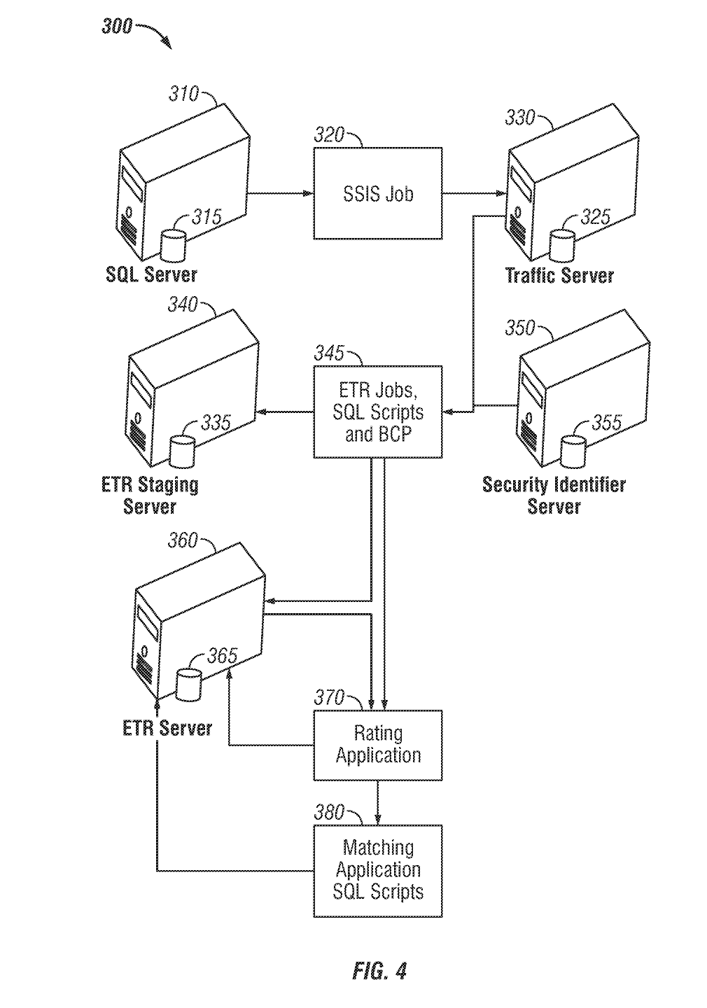

FIG. 4 illustrates a graphical representation of one embodiment of the media posting system 200. The system 200 can be employed to manage multiple advertising spots 218 and campaigns associated with varying media outlets 210 in a complex media environment. A SQL server 310 including an SQL database 315 may provide a SSIS (SQL server integration services) job 320 to the traffic sever 330 in order to import the media advertising order 285 from the advertiser 295. The SQL, server 310 may include an SSIS package that can be scheduled via a SQL agent in order to load the ordered data 285 into a traffic database 325 associated with the traffic server 330. Note that the SSIS job 320 may be a component of the Microsoft SQL server database software which can be employed to perform a broad range of data migration tasks. The SSIS job 320 may provide a platform for data integration and workflow applications which feature a fast and flexible data warehousing tool utilized for data extraction, transformation, and loading (ETL).

The SSIS job 320 may also be employed to automate maintenance of SQL server database 315 and may update multidimensional cube data. The traffic server 330 in association with a security identification server 350 may provide one or more exact time report or run (ETR) jobs associated with SQL scripts and bulk copy program (BCP) 345 to an ETR staging server 340 and a rating application 370. Note that the bulk copy program can be a command-line utility that ships with the SQL server 310. The bulk copy program can be employed to import and export large amounts of data in and out of the SQL server database 315. The bulk copy program may transfer the SQL scripts from the security database 355 of the security identification server 350 and the traffic database 325 to the ETR staging server 340.

The security identification server 350 may transmit data to an ETR staging database 335 associated with the ETR staging server 340. The rating application 370 may further update the survey book associated with the rating unit 230 and thereby provide the audience delivery data 260 with respect to the media advertising order 285. The rating application 370 can be a C+ application that runs on the rating unit 230, but may also be in any computing language known to those skilled in the art. The survey books associated with the rating unit 230 can be stored into a hard drive, such as mass storage 107. The system 200 may further utilize the rating application 370 in order to generate matching SQL scripts 380 with respect to an ETR server 360. Database 365 may be updated to include matched order data, exact times data, and audience data. The matching application can include one or more SQL stored procedures that can match the traffic and security identification information on a security identification contract number and finds appropriate media advertising order 285 in the media outlet 210.

FIG. 5 illustrates one embodiment of a high level flow chart of operation illustrating logical operational steps of a method 400 for managing the media advertising order 285 with respect to the media outlet 210. Note that the method 400 can be implemented in the context of a computer-usable medium that may contain a program product including, for example, a module or group of modules. The media advertising order 285 can be ordered via the rep ordering application module 152, as illustrated at block 410. The exact time data 215 with respect to the media outlet 210 can be extracted from the traffic sub-system 220, as indicated at block 420. The exact time data 215 and ordered spot data 250 can be stored in the database 240 (e.g., a SQL database) and linked with the media advertising order 285, as depicted at block 430.

The audience delivery data 260, which can be obtained from the rating unit 230, can be merged into the database 240 and linked with the media advertising order 285 and the exact time data 215, as indicated at block 440. The estimated audience delivery data 260 associated with the media advertising order 285 can be compared to the actual audience delivery with respect to the media advertising order 285, as illustrated at block 450. One or more reports with respect to the media advertising order 285 can be simultaneously displayed on the user interface 280, as depicted at block 460. In some embodiments, a report may include some or all of the information and features discussed in more detail in in FIGS. 9 and 10. Such an optimized mechanism can interactively manage the media advertising order 285 with respect to the media outlet 210 in a simple and efficient manner. In some embodiments, the user interface 280 can be web-based. In some embodiments, however, the user interface 280 can be an application that operates independently of a web browser.

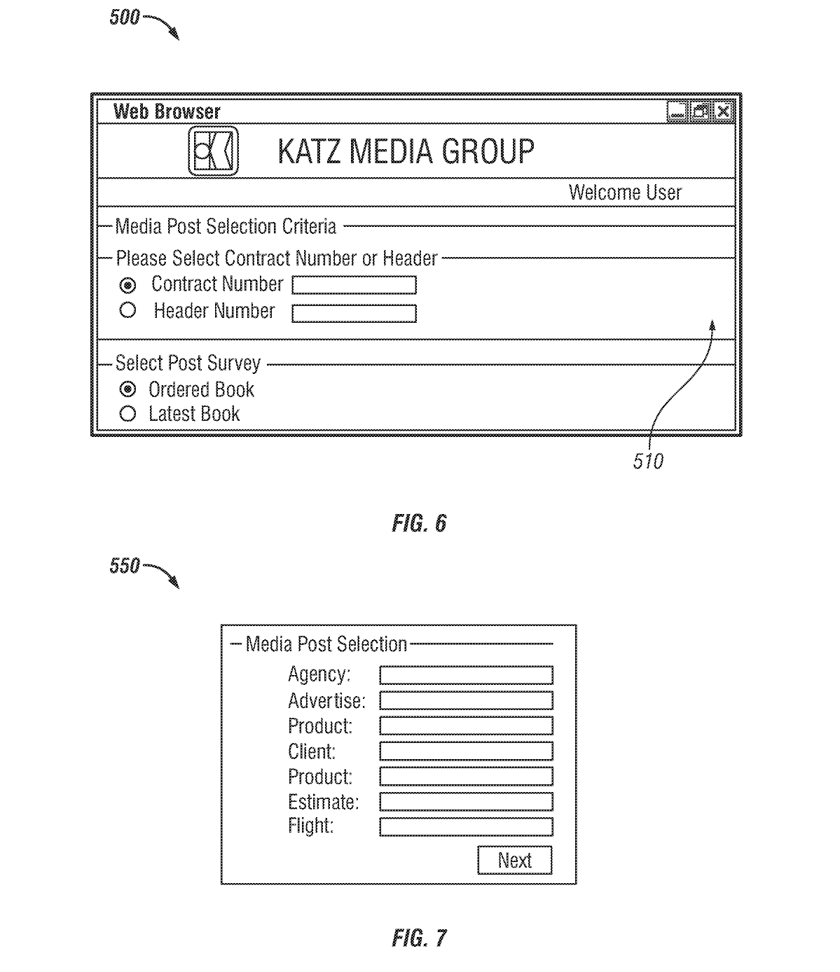

FIG. 6 illustrates one embodiment of a GUI 500 that displays a media post selection criteria 510. Note that the GUI 500, 550, 600, and/or 700 can be implemented utilizing a GUI such as, for example, the GUI 153 depicted in FIG. 1 herein, and may be provided by a module such as, for example, module 152 (i.e., a software application). GUI 500, 550, 600, and/or 700 can be displayed via a display device such as monitor 106 depicted in FIG. 1. In the illustrated figures herein, the depicted GUI can be implemented in the context of a GUI “window”. Note that in computing, a GUI window can generally be a visual area containing some type of graphical user interface (e.g., GUI 153). Such a “window” may be of any shape, such as square or rectangular, and displays the output of and may allow input to one or more processes. Such windows are primarily associated with graphical displays, where they can be manipulated with a variety of user interfaces. For example, some embodiments may include a mouse cursor such as, for example, the pointing device 105 depicted in FIG. 1. As further example, some embodiments may include a touch sensitive screen so that the processes may be manipulated by positioning a finger or other item on or near the computer display. In addition, some embodiments may allow for the processes to be manipulated by sound, voice, or light pen. The embodiments illustrated in FIGS. 6-9 may be manipulated in any of these methods discussed herein. A GUI using windows as one of its main “metaphors” is often referred to as a windowing system. A contract number or a header number can be selected by the user 295 with respect to the media advertising order 285 in order to access the reports with respect to the media posting application module 275. The markets and/or stations associated with the contract number or the header number can be displayed on the GUI 500.

FIG. 7 illustrates one embodiment of a graphical user interface of a header screen 550 associated with the media posting application module 275. The header screen 550 may display a variety of information. For example, header screen 550 may include information such as agency, advertiser, product, client, and estimate and flight information associated with the contract number and/or header number selected by the advertiser 295. On selecting the ‘Next’ button in the header screen 550, the user interface may direct the user 295 to a selection screen 600. In some embodiments, some or all of the information input by the user into the header screen 550 is saved into a hard drive for later retrieval.

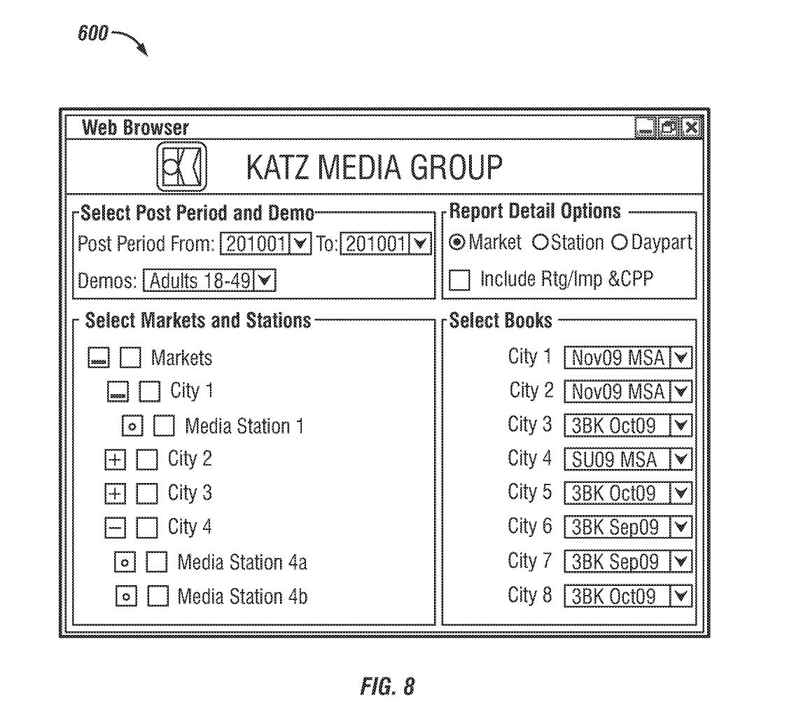

FIG. 8 illustrates one embodiment of the graphical user interface of the selection screen 600 associated with the media posting application 275. The selection screen 600 may permit the user 295 to select post period, report detail options, select market and station, and survey books with respect to the media advertising order 285. The information provided by the user 295 can be saved into a hard drive and can be employed to generate a post analysis report with respect to the media advertising order 285. Such information can be displayed within a report viewer window 700.

FIG. 9 illustrates one embodiment of a GUI of a report viewer window 700 with respect to the media advertising order 285. Note that the GUI as utilized herein generally refers to a type of environment that represents programs, files, options, and so forth by means of graphically displayed icons, menus, and dialog boxes displayed on a screen. A user can interact with the user interface to select and activate such options by pointing and clicking with a user input device such as, for example, a touch screen, a keyboard or the like. A particular item can function in the same manner to the user in all applications because the user interface provides standard software routines to handle these elements and reports the user's actions.

The report 700 may include information relating to the agency, advertiser, product, CPE, market, flight dates, post period, survey book, post book, and demo within the header of the report. The details of the report can be collapsed or expanded at various portions of the display. In some embodiments, the details of the report can be collapsed at either the market, station or day part level. The collapsed level of details permits the advertiser to quickly determine the projected values based on the number of spots, rate, rating, and CPE that are ordered and aired. The report viewer screen 700 also permits the user 295 to render the report in different formats such as XML file, CSV, TIFF, PDF, Web Archive, and Excel. The system and method disclosed herein therefore may effectively calculate the audience delivery data for the media order, which facilitates the advertiser in making the media advertising purchase decision with respect to the selected advertising spot.

FIG. 10 illustrates one embodiment of a graphical user interface that displays data contained within a report viewer 800. Audience delivery data 260 for a particular station within a particular city can be expanded under the media or radio station identification information. In this expanded post analysis report, the details of the advertising slot are shown per week and per ordered time slot. The expanded level of details permits the user to investigate the projected values based on the number of spots, rate, rating, and CPE that are ordered and aired. The report 800 may include information relating to the agency, advertiser, product, CPE, market, flight dates, post period, survey book, post book, and demo within the header of the report.

Based on the foregoing, it can be appreciated that varying embodiments are disclosed herein, including preferred and alternative embodiments. For example, in one embodiment, a method for managing an advertising spot or campaign, can be implemented. Such a method can include, for example, receiving a media advertising order with respect to a media outlet via a media ordering application in order to thereafter extract exact time data associated with the media outlet from a traffic sub-system, merging audience delivery data obtained from a rating unit via a media posting application into a database in order to thereafter link the audience delivery data with the media advertising order and the exact time data, and generating one or more reports with respect to the media advertising order via the media posting application based on a comparison between the estimated audience delivery data associated with the media advertising order and an actual audience delivery data.

In another embodiment, an operation can be implemented for storing the exact time data in the database in order to thereafter link the exact time data with the media advertising order. In still another embodiment, the aforementioend database can comprise a SQL database. In yet other embodiments, the aforementioned media outlet can be a radio station. In other embodiments, an operation can be implemented for generating one or more reports with respect to the media advertising order based on one or more of the following criterion: a market criterion, a media station criterion, a national buy criterion, etc.

In other embodiments, the media posting application can be configured to generate one or more of the following types of report: a media advertising order versus exact time report, a promised audience delivery report, an actual audience delivery report, or a percentage of promised audience delivery report. In still other embodiments, the aforementioned audience delivery data can be one or more order survey books.

In other embodiments, a system can be implemented for managing an advertising spot or campaign. Such a system can include, for example, a processor, a data bus coupled to the processor, and a non-transient computer-readable medium embodying computer code. Such a computer-readable medium can be coupled to the data bus. The non-transient computer program code can include, for example, instructions executable by the processor and configured for receiving a media advertising order with respect to a media outlet via a media ordering application in order to thereafter extract exact time data associated with the media outlet from a traffic sub-system, merging audience delivery data obtained from a rating unit via a media posting application into a database in order to thereafter link the audience delivery data with the media advertising order and the exact time data, and generating one or more reports with respect to the media advertising order via the media posting application based on a comparison between the estimated audience delivery data associated with the media advertising order and an actual audience delivery data.

In some embodiments, the aforementioned instructions executable by the processor can be further configured for storing the exact time data in the database in order to thereafter link the exact time data with the media advertising order. In other embodiments of such a system, the aforementioned database can be a SQL database. In still other embodiments of such a system, the aforementioned media outlet can be, for example, a radio station.

In yet other embodiments, the aforementioned instructions executable by the processor can be further configured for generating one or more reports with respect to the media advertising order based on one or more of the following criterion: a market criterion, a media station criterion, a national buy criterion, etc. In still other embodiments, the aforementioned instructions executable by the processor can be further configured for configuring the media posting application to generate one or more of the following types of report: a media advertising order versus exact time report, a promised audience delivery report, an actual audience delivery report, or a percentage of promised audience delivery report. In still other embodiments of such a system, the audience delivery data can include, for example, one or more survey books.

In still another embodiment, an apparatus can be implemented, which includes one or more processor readable storage devices having non-transient processor readable code on the processor readable storage devices, the non-transient processor readable code for programming one or more processor to perform a method for managing a media advertising order. Such a method can include, for example, receiving a media advertising order with respect to a media outlet via a media ordering application in order to thereafter extract exact time data associated with the media outlet from a traffic sub-system, merging audience delivery data obtained from a rating unit via a media posting application into a database in order to thereafter link the audience delivery data with the media advertising order and the exact time data, and generating one or more reports with respect to the media advertising order via the media posting application, the report based on a comparison between the estimated audience delivery data associated with the ordered advertising spot and an actual audience delivery data.

In another embodiment of such an apparatus, such a method can include, for example, storing the exact time data in the database in order to thereafter link the exact time data with the media advertising order. In other embodiments of such an apparatus, the aforementioned database can be, for example, a SQL database. In yet other embodiments of such an apparatus, the aforementioned media outlet can be, for example, a radio station.

In yet other embodiments of such an apparatus, the aforementioned method can include, for example, generating one or more reports with respect to the media advertising order based on one or more of the following criterion: a market criterion, a media station criterion, a national buy criterion, etc. In still other embodiments of such an apparatus, the non-transient processor readable code can configure the media posting application to generate one or more of the following types of report: a media advertising order versus exact time report, a promised audience delivery report, an actual audience delivery report; or a percentage of promised audience delivery report.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for managing an advertising spot or campaign, comprising:
receiving a media advertising order with respect to a media outlet via a media ordering application in order to thereafter extract exact time data associated with said media outlet from a traffic sub-system;
merging audience delivery data obtained from a rating unit via a media posting application into a database in order to thereafter link said audience delivery data with said media advertising order and said exact time data; and
generating at least one report with respect to said media advertising order via said media posting application based on a comparison between said estimated audience delivery data associated with said media advertising order and an actual audience delivery data.

2. The method of claim 1 further comprising storing said exact time data in said database in order to thereafter link said exact time data with said media advertising order.

3. The method of claim 1 wherein said database comprises a SQL database.

4. The method of claim 1 wherein said media outlet comprises a radio station.

5. The method of claim 1 further comprising generating at least one report with respect to said media advertising order based on at least one of the following criterion:
a market criterion;
a media station criterion; or
a national buy criterion.

6. The method of claim 1 further comprising configuring the media posting application to generate at least one of the following types of report:
a media advertising order versus exact time report;
a promised audience delivery report;
an actual audience delivery report; or
a percentage of promised audience delivery report.

7. The method of claim 1 wherein said audience delivery data comprises at least one order survey book,

8. A system for managing an advertising spot or campaign, comprising:
a processor;
a data bus coupled to said processor; and
a non-transient computer-readable medium embodying computer code, said computer-readable medium being coupled to said data bus, said non-transient computer program code comprising instructions executable by said processor and configured for:
receiving a media advertising order with respect to a media outlet via a media ordering application in order to thereafter extract exact time data associated with said media outlet from a traffic sub-system;
merging audience delivery data obtained from a rating unit via a media posting application into a database in order to thereafter link said audience delivery data with said media advertising order and said exact time data; and
generating at least one report with respect to said media advertising order via said media posting application based on a comparison between said estimated audience delivery data associated with said media advertising order and an actual audience delivery data.

9. The system of claim 8 wherein said instructions executable by said processor are further configured for storing said exact time data in said database in order to thereafter link said exact time data with said media advertising order.

10. The system of claim 8 wherein said database comprises a SQL database.

11. The system of claim 8 wherein said media outlet comprises a radio station.

12. The system of claim 8 wherein said instructions executable by said processor are further configured for generating at least one report with respect to said media advertising order based on at least one of the following criterion:
a market criterion;
a media station criterion; or
a national buy criterion.

13. The system of claim 8 wherein said instructions executable by said processor are further configured for configuring said media posting application to generate at least one of the following types of report:
a media advertising order versus exact time report;
a promised audience delivery report;
an actual audience delivery report; or
a percentage of promised audience delivery report.

14. The system of claim 8 wherein said audience delivery data comprises at least one order survey book.

15. An apparatus comprising one or more processor readable storage devices having non-transient processor readable code on said processor readable storage devices, said non-transient processor readable code for programming one or more processors to perform a method for managing a media advertising order, comprising:
receiving a media advertising order with respect to a media outlet via a media ordering application in order to thereafter extract exact time data associated with said media outlet from a traffic sub-system;
merging audience delivery data obtained from a rating unit via a media posting application into a database in order to thereafter link said audience delivery data with said media advertising order and said exact time data; and
generating at least one report with respect to said media advertising order via said media posting application, said report based on a comparison between said estimated audience delivery data associated with said ordered advertising spot and an actual audience delivery data.

16. The apparatus of claim 15 further comprising storing said exact t e data in said database in order to thereafter link said exact time data with said media advertising order.

17. The apparatus of claim 15 wherein said database comprises a SQL database.

18. The apparatus of claim 15 wherein said media outlet comprises a radio station.

19. The apparatus of claim 15 further comprising generating at least one report with respect to said media advertising order based on at least one of the following criterion:
a market criterion;
a media station criterion; or
a national buy criterion.

20. The apparatus 15 further comprising non-transient processor readable code for configuring the media posting application to generate at least one of the following types of report:
a media advertising order versus exact time report;
a promised audience delivery report;
an actual audience delivery report; or
a percentage of promised audience delivery report
